(19) United States
(12) Patent Application Publication
(10) Pub. No.: US 2025/0269358 A1
(43) Pub. Date: Aug. 28, 2025

(54) CATALYST FOR NAPHTHA MAXIMIZATION AND METHOD FOR PREPARING THEREOF

(71) Applicant: HINDUSTAN PETROLEUM CORPORATION LIMITED, Bangalore (IN)

(72) Inventors: Enumula Siva Sankar, Bengaluru (IN); Nagaraj Anbu, Bengaluru (IN); Amit Behera, Bengaluru (IN); Kanuparthy Naga Raja, Bengaluru (IN)

(21) Appl. No.: 19/066,737

(22) Filed: Feb. 28, 2025

(30) Foreign Application Priority Data
Feb. 28, 2024 (IN) 202441014619

(51) Int. Cl. B01J 23/881; B01J 35/40; B01J 35/54; B01J 37/00; B01J 37/02; B01J 37/03; B01J 37/04; B01J 37/06; B01J 37/08; C10G 47/20

(52) U.S. Cl. CPC B01J 23/881; B01J 35/40; B01J 35/54; B01J 37/009; B01J 37/0236; B01J 37/033; B01J 37/04; B01J 37/06; B01J 37/088; C10G 47/20

(57) ABSTRACT

The present invention pertains to a catalyst comprising well-defined structured metal oxides and mixed metal oxide and a method for the preparation of the catalyst by hydrolysis and precipitation methods. The catalyst comprises a first metal oxide and a second metal oxide, wherein metal of the first metal oxide is molybdenum (Mo) and metal of the second metal oxide is selected from a group comprises iron (Fe), aluminium (Al), silicon (Si) and a mixture thereof; wherein the catalyst has an atomic ratio of Mo to Fe, Al or Si in a range of 0.8 to 6. The catalyst is utilized for the maximization of naphtha through hydrocracking of petroleum feedstock.

### CROSS-REFERENCE TO RELATED APPLICATIONS

This application claims the benefit of Indian application Ser. No. 202441014619 filed Feb. 28, 2024, the disclosure of which is incorporated herein by reference in its entirety.

### FIELD OF THE INVENTION

The present invention pertains to a catalytic hydrocracking. More particularly, the present invention pertains to a catalyst for naphtha maximization of a petroleum feedstock through hydrocracking and a process for the preparation of the catalyst.

### BACKGROUND OF THE INVENTION

In petroleum industry, production of petrochemical feedstock is done through catalytic cracking of vacuum gas oil. However, there are challenges in supplying good petroleum feedstock having low sulfur, vacuum gas oil content and residue content. The heavy petroleum feedstocks contain high level of asphaltenes, metal content, nitrogen and sulfur content. Hence, the processing of heavy petroleum feedstock under established processes becomes difficult. The processing of heavy feedstock is generally done either by carbon rejection route or hydrogen addition route. The carbon rejection route produces low yield of light hydrocarbons. The hydrogen addition route involves cracking and hydrogenation reactions which produces high yield of middle distillates. In the prior art, most of the hydrocracking of petroleum feedstock produce middle distillates as major product and there is no significant change in the naphtha content. Naphtha is the petrochemical feedstock to produce monomers such as ethylene, propylene, and BTX (benzene, toluene, xylene). With increase in demand for petrochemical feedstock there is room to develop efficient catalytic process for maximization of naphtha through hydrocracking of petroleum feedstock (mostly direct crude oil, vacuum residue).

U.S. Pat. No. 7,238,273B2 discloses a process for conversion of heavy petroleum feedstock through slurry hydrocracking using a slurry composition containing Group VIB metal oxide. The slurry composition is able to produce middle distillates with no change in naphtha content.

Rawat et. al., discloses three different type of catalysts for hydrocracking of crude oil. [Fuel, 330, (2022) 125448]. There is an increment in middle distillates yield but not in naphtha yield in the product.

U.S. Pat. No. 10,717,940 B2 discloses a supported catalyst containing Mo for conversion of heavy petroleum feedstock through hydrocracking reaction and produces middle distillates.

EP2291238 B1 discloses a two catalysts system containing MoS₂ based and acidic support such as zeolites for conversion of heavy petroleum feedstock to middle distillates.

There are reports on catalysts and processes for hydrocracking of vacuum residue, heavy hydrocarbons to middle distillates in slurry mode of operation. Most of the reported catalyst systems are expensive oil soluble metal-based catalysts which did not demonstrate a significant change in naphtha content after reaction.

### OBJECTIVES OF THE INVENTION

The main objective of the present invention is to provide a catalyst for naphtha maximization of petroleum feedstock through hydrocracking.

Another objective of the present invention is to provide a process for the preparation of the catalyst for hydrocracking.

Another objective of the present invention is to provide a process for naphtha maximization of petroleum feedstock through hydrocracking.

### SUMMARY OF THE INVENTION

This summary is provided to introduce a selection of concepts, in a simplified format, that are further described in the detailed description of the invention. This summary is neither intended to identify key or essential inventive concepts of the invention and nor is it intended to determine the scope of the invention.

The present invention provides a catalyst for naphtha maximization of a petroleum feedstock through hydrocracking comprises a first metal oxide and a second metal oxide, wherein metal of the first metal oxide is molybdenum (Mo) and metal of the second metal oxide is selected from a group comprises iron (Fe), aluminium (Al), silicon (Si) and a mixture thereof; wherein the catalyst has an atomic ratio of Mo to Fe, Al or Si in a range of 0.8 to 6.

The present invention also provides a method for preparation of a catalyst for naphtha maximization of petroleum feedstock through hydrocracking, said method comprises:
i. adding a solution of a first metal precursor to an aqueous solution of a second metal precursor and formic acid to form a reaction mixture; wherein the first metal precursor comprises molybdenum (Mo), the second metal precursor comprises a metal selected from iron (Fe), aluminium (Al), silicon (Si) and a mixture thereof,
ii. stirring the reaction mixture;
iii. refluxing the reaction mixture followed by ageing to obtain a solid product;
iv. separating the solid product, followed by washing with a solvent to obtain a washed product; and
v. drying the washed product to obtain the catalyst.

The present invention provides a process for naphtha maximization of a petroleum feedstock through hydrocracking, the process comprises:
i. adding a catalyst to the petroleum feedstock to obtain a dispersion; wherein the catalyst comprises a first metal oxide and a second metal oxide, wherein metal of the first metal oxide is molybdenum (Mo) and metal of the second metal oxide is selected from a group comprises iron (Fe), aluminium (Al), silicon (Si) and a mixture thereof; wherein the catalyst has an atomic ratio of Mo to Fe, Al or Si in a range of 0.8 to 6, and
ii. contacting the dispersion with hydrogen under a slurry phase reaction condition to obtain a product stream.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts the morphological features of the catalyst.

### DETAILED DESCRIPTION OF THE INVENTION

The present invention provides a catalyst for naphtha maximization of a petroleum feedstock through direct hydrocracking of crude oil into naphtha and middle distillates which is beneficial in terms of product quality and quantity. The solid metal oxide based dispersed catalyst for maximization of naphtha in hydrocracking of petroleum feedstock such as crude oil, vacuum residue, heavy hydrocarbon.

For the purpose of promoting an understanding of the principles of the invention, reference will now be made to the embodiments in the specific language to describe the same. It will nevertheless be understood that no limitation of the scope of the invention is thereby intended, such alterations and further modifications in the illustrated process, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The composition, methods, and examples provided herein are illustrative only and not intended to be limiting.

The articles “a”, “an” and “the” are used to refer to one or to more than one (i.e., to at least one) of the grammatical object of the article.

The term “some” as used herein is defined as “none, or one, or more than one, or all”. Accordingly, the terms “none”, “one”, “more than one”, “more than one, but not all” or “all” would all fall under the definition of “some”. The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments”.

More specifically, any terms used herein such as but not limited to “includes”, “comprises”, “has”, “consists” and grammatical variants thereof is inclusive or open-ended and does not exclude additional, unrecited elements or method steps. The specification will be understood to also include embodiments which have the transitional phrase “consisting of” or “consisting essentially of” in place of the transitional phrase “comprising”. The transitional phrase “consisting of” excludes any element, step, or ingredient not specified in the claim, except for impurities associated therewith. The transitional phrase “consisting essentially of” limits the scope of a claim to the specified materials or steps “and those that do not materially affect the basic and novel characteristic(s)” of the claimed invention.

Use of the phrases and/or terms such as but not limited to “a first embodiment”, “a further embodiment”, “an alternate embodiment”, “one embodiment”, “an embodiment”, “multiple embodiments”, “some embodiments”, “other embodiments”, “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

The terminology and structure employed herein is for describing, teaching, and illuminating some embodiments and their specific features and elements and does not limit, restrict, or reduce the spirit and scope of the invention.

The present invention discloses a catalyst comprising well-defined structured metal oxides and or mixed metal oxide and a method for the preparation of the catalyst by hydrolysis and precipitation methods. The catalyst is further utilized for the maximization of naphtha through hydrocracking of petroleum feedstock.

The present invention provides a catalyst for naphtha maximization of a petroleum feedstock through hydrocracking comprises a first metal oxide and a second metal oxide, wherein metal of the first metal oxide is molybdenum (Mo) and metal of the second metal oxide is selected from a group comprises iron (Fc), aluminium (Al), silicon (Si) and a mixture thereof; wherein the catalyst has an atomic ratio of Mo to Fe, Al or Si in a range of 0.8 to 6.

In an embodiment of the present invention, the catalyst has a mean particle size in a range of 4 to 25 μm, preferably in a range of 15 to 20 μm.

In an embodiment of the present invention, the catalyst has a rod like structure having an aspect ratio in a range of 5 to 15.

The present invention also provides a method for preparation of a catalyst for naphtha maximization of petroleum feedstock through hydrocracking, said method comprises:
i. adding a solution of a first metal precursor to an aqueous solution of a second metal precursor and formic acid to form a reaction mixture; wherein the first metal precursor comprises molybdenum (Mo), the second metal precursor comprises a metal selected from iron (Fe), aluminium (Al), silicon (Si) or mixture thereof,
ii. stirring the reaction mixture;
iii. refluxing the reaction mixture followed by ageing to obtain a solid product;
iv. separating the solid product, followed by washing with a solvent to obtain a washed product; and
v. drying the washed product to obtain the catalyst.

In an embodiment of the present invention, the first metal precursor comprising molybdenum (Mo) is selected from (NH₄)₆Mo₇O₂₄·4H₂O and Na₂MoO₄·2H₂O; the second metal precursor comprising iron (Fe) is selected from Fe(NO₃)₃·9H₂O and Fe(SO₄)₃·9H₂O; the second metal precursor comprising aluminium (Al) is selected from Al(SO₄)₃·9H₂O and Al(NO₃)₃·9H₂O; and the second metal precursor comprising silicon (Si) is Si(OC₂H₅)₄.

In an embodiment of the present invention, the reaction mixture has a pH in a range of 1 to 4.

In an embodiment of the present invention, the reaction mixture has a metal content in a range of 1000 to 5000 ppm.

In an embodiment of the present invention, the solution of the first metal precursor is added to the solution of the second metal precursor at a temperature in a range of 30 to 60° C.

In a preferred embodiment of the present invention, the solution of the first metal precursor is added to the solution of the second metal precursor at a temperature in a range of 30to 50° C.

In an embodiment of the present invention, the refluxing is performed at a temperature in a range of 65 to 100° C. for 0.5 to 6 h under constant stirring.

In an embodiment of the present invention, the ageing is performed at a temperature in a range of 65 to 110° C. for 0.5 to 6 h.

In a preferred embodiment of the present invention, the refluxing and the ageing is performed at a temperature in a range of 75 to 100° C.

In an exemplary embodiment of the present invention, the solid product is separated through filtration.

In an embodiment of the present invention, the solid product is washed with the solvent selected from deionized water and methanol.

In an embodiment of the present invention, the washed product is dried at a temperature in a range of 30 to 60° C.

The present invention provides a process for naphtha maximization of a petroleum feedstock through hydrocracking, the process comprises:
i. adding a catalyst to the petroleum feedstock to obtain a dispersion; wherein the catalyst comprises a first metal oxide and a second metal oxide, wherein metal of the first metal oxide is molybdenum (Mo) and metal of the second metal oxide is selected from a group comprises iron (Fe), aluminium (Al), silicon (Si) and a mixture thereof; wherein the catalyst has an atomic ratio of Mo to Fe, Al or Si in a range of 0.8 to 6, and
ii. contacting the dispersion with hydrogen under a slurry phase reaction condition to obtain a product stream.

In an embodiment of the present invention, the dispersion is prepared by adding 0.1 to 0.5 weight % of the catalyst having a mean particle size of 4 to 25 μm, preferably 15-20 μm in the petroleum feedstock.

In an embodiment of the present invention the petroleum feedstock comprises a petroleum crude, a heavy hydrocarbon, and a vacuum residue.

In an embodiment of the present invention, the petroleum feedstock comprises at least 3 to 5 weight % sulphur, 4 to 8 weight % CCR, 3 to 8 weight % asphaltenes and at least 30 weight % hydrocarbons having a boiling point >540° C.

In an embodiment of the present invention, the dispersion is prepared by adding 0.1 to 0.5 weight % of the catalyst having a particle size of 15 to 20 μm in the petroleum feedstock.

In an embodiment of the present invention, the catalyst is in a solid powdered form.

In an embodiment of the present invention, the hydrocracking of the petroleum feedstock is performed under the slurry phase reaction condition at a partial pressure in a range of 80 to 100 bar, an operating temperature in a range of 370 and 420° C. and at a residence time of 0.5 to 6 h.

In an embodiment of the present invention, the catalyst for naphtha maximization of the petroleum feedstock through hydrocracking exhibits at least 75 to 90% conversion of the hydrocarbons having the boiling point >540° C. and 25 to 40% yield of naphtha in the product stream.

In an embodiment of the present invention, the product stream has naphtha containing at least 60% of saturated hydrocarbons.

### EXAMPLES

The present disclosure with reference to the accompanying examples describes the present invention. However, those of skill in the art should, in light of the present disclosure, appreciate that many changes can be made in the specific embodiments which are disclosed and still obtain a like or similar result without departing from the spirit and scope of the invention. It is understood that the examples are provided for the purpose of illustrating the invention only and are not intended to limit the scope of the invention in any way.

### Example 1: Catalyst Preparation

a) 8.28 g of ammonium heptamolybdate tetrahydrate was dissolved in 50 ml of deionized water and added to aqueous solution of Fe(NO₃)₃·9H₂O and formic acid until pH of the resultant solution reaches to 2 with continuous stirring at 50° C. for 1 h. The resulting mixture was refluxed at 80° C. for 1 h followed by aging for 1 h without stirring. The yielded solid was filtered, washed with deionized water and methanol, and dried at 30° C. The aspect ratio of the catalyst having rod like structure is 18.
b) 8.28 g of ammonium heptamolybdate tetrahydrate was dissolved in 50 ml of deionized water and added to aqueous solution of Al(NO₃)₃·9H₂O and formic acid until pH of the resultant solution reaches to 2 with continuous stirring at 50° C. for 1 h. The resulting mixture was refluxed at 80° C. for 1 h followed by aging for 1 h without stirring. The yielded solid was filtered, washed with deionized water and methanol, and dried at 30° C. The aspect ratio of the catalyst having rod like structure is 20.
c) 8.28 g of ammonium heptamolybdate tetrahydrate was dissolved in 50 ml of deionized water and added to aqueous solution of Tetraethyl orthosilicate and formic acid until pH of the resultant solution reaches to 2 with continuous stirring at 50° C. for 1 h. The resulting mixture was refluxed at 80° C. for 1 h followed by aging for 1 h without stirring. The yielded solid was filtered, washed with deionized water and methanol, and dried at 30° C. The aspect ratio of the catalyst having rod like structure is 15.
d) 8.28 g of ammonium heptamolybdate tetrahydrate was dissolved in 50 ml of deionized water and added to aqueous solution of aluminium isopropoxide and formic acid until pH of the resultant solution reaches to 2 with continuous stirring at 50° C. for 1 h. The resulting mixture was refluxed at 80° C. for 1 h followed by aging for 1 h without stirring. The yielded solid was filtered, washed with deionized water and methanol, and dried at 30° C. The aspect ratio of the catalyst having rod like structure is 10.

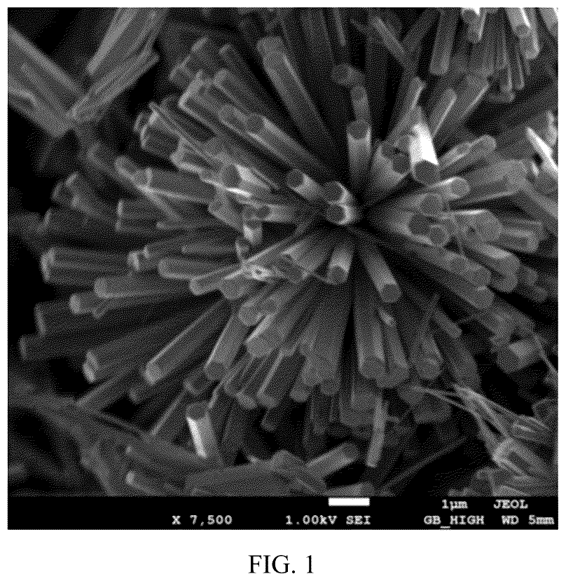

The morphological features of the catalyst are shown in FIG. 1.
e) 8.28 g of ammonium heptamolybdate tetrahydrate was dissolved in 50 ml of deionized water and added to aqueous solution of aluminium isopropoxide and formic acid until pH of the resultant solution reaches to 1 with continuous stirring at 50° C. for 1 h. The resulting mixture was refluxed at 100° C. for 1 h followed by aging for 6 h without stirring. The yielded solid was filtered, washed with deionized water and methanol, and dried at 30° C. The aspect ratio of the catalyst having rod like structure is 30.

### Example 2

a) The prepared catalysts of example 1a, 1b, 1c, 1d, and le were evaluated in a batch reactor with 0.5 wt. % of catalyst with respect to feed quantity. The petroleum crude feed with a characteristic sulfur content of 3.1 wt. %, asphaltene content of 4.3%, and CCR of 5.5% and 30 wt. % of hydrocarbons having boiling point above 540° C. The crude hydrocracking reaction performed at 420° C. and 100 bar of hydrogen pressure with residence time of 2 h. The liquid product was characterized through simulated distillation to get the different fractions. The catalytic activity results are presented in Table 1.

TABLE 1
CATALYTIC ACTIVITY RESULTS OF PREPARED CATALYST

| | | Product | | | | |
|---|---|---|---|---|---|---|
| Various fractions | | Example | Example | Example | Example | Example |
| wt. % | Feed | 1a | 1b | 1c | 1d | 1e |
| H₂S | — | 0.31 | 0.36 | 0.29 | 0.5 | 0.39 |
| Dry Gas | — | 1.81 | 1.79 | 1.2 | 1.2 | 0.80 |
| LPG | — | 0.69 | 0.68 | 0.39 | 0.5 | 0.29 |
| Naphtha (IBP-180° C.) | 13.7 | 28.78 | 26.49 | 30.62 | 39.9 | 27.86 |
| Kerosene (180-250° C.) | 11.8 | 16.43 | 17.31 | 15.94 | 16.4 | 16.34 |
| Diesel (250-370° C.) | 22.9 | 28.89 | 30.07 | 30.52 | 24.5 | 30.60 |
| VGO (370-540° C.) | 20.7 | 19.23 | 19.24 | 17.02 | 13.5 | 19.98 |
| VR (540° C.+) | 30.9 | 3.87 | 4.06 | 4.01 | 3.6 | 3.74 |
| 540+ conversion, % | | 87.55 | 86.93 | 87.06 | 89.2 | 88 |
| H₂ Consumption, % | | 0.82 | 0.57 | 0.84 | 0.7 | 0.77 |

b) The prepared Example 1d catalyst was evaluated in a batch reactor with 0.1 wt. % of catalyst with respect to feed quantity. The petroleum crude feed with a characteristic of 30 wt. % boiling above 540° C., sulfur content of 3.1 wt. %, asphaltene content of 4.3%, and CCR of 5.5%. The crude hydrocracking reaction performed at 420° C. and 100 bar of hydrogen pressure with residence time of 2 h. The liquid product was characterized through simulated distillation to get the different fractions. The catalytic activity results are presented in Table 2.

TABLE 2
CATALYTIC ACTIVITY RESULTS OF
PREPARED EXAMPLE 1D CATALYST

| Various fractions wt. % | Feed | Product |
|---|---|---|
| H₂S | — | 0.30 |
| Dry Gas | — | 2.01 |
| LPG | — | 0.84 |
| Naphtha (IBP-180° C.) | 13.7 | 29.76 |
| Kerosene (180-250° C.) | 11.8 | 17.62 |
| Diesel (250-370° C.) | 22.9 | 30.23 |
| VGO (370-540° C.) | 20.7 | 16.17 |
| VR (540° C.+) | 30.9 | 3.08 |
| 540+ conversion, % | | 90.1 |
| H₂ Consumption, % | | 0.4 |

What is claimed is:

1. A catalyst for naphtha maximization of a petroleum feedstock through hydrocracking comprises a first metal oxide and a second metal oxide, wherein metal of the first metal oxide is molybdenum (Mo) and metal of the second metal oxide is selected from a group comprises iron (Fe), aluminium (Al), silicon (Si) and a mixture thereof; wherein the catalyst has an atomic ratio of Mo to Fe, Al or Si in a range of 0.8 to 6.

2. The catalyst as claimed in claim 1, wherein the catalyst has a mean particle size in a range of 4 to 25 μm, preferably in a range of 15 to 20 μm.

3. The catalyst as claimed in claim 1, wherein the catalyst has a rod like structure having an aspect ratio in a range of 5 to 15.

4. A method for preparation of a catalyst for naphtha maximization of petroleum feedstock through hydrocracking, said method comprises:
i. adding a solution of a first metal precursor to an aqueous solution of a second metal precursor and formic acid to form a reaction mixture; wherein the first metal precursor comprises molybdenum (Mo), and the second metal precursor comprises a metal selected from iron (Fe), aluminium (Al), silicon (Si) and a mixture thereof,
ii. stirring the reaction mixture;
iii. refluxing the reaction mixture followed by ageing to obtain a solid product;
iv. separating the solid product, followed by washing with a solvent to obtain a washed product; and
v. drying the washed product to obtain the catalyst.

5. The method as claimed in claim 4, wherein the first metal precursor comprising molybdenum (Mo) is selected from (NH₄)₆Mo₇O₂₄·4H₂O and Na₂MoO₄·2H₂O; the second metal precursor comprising iron (Fe) is selected from Fe(NO₃)₃·9H₂O and Fe(SO₄)₃·9H₂O; the second metal precursor comprising aluminium (Al) is selected from Al(SO₄)₃·9H₂O, and aluminium isopropoxide and Al(NO₃)₃·9H₂O; and the second metal precursor comprising silicon (Si) is Si(OC₂H₅)₄.

6. The method as claimed in claim 4, wherein the reaction mixture has a pH in a range of 1 to 4.

7. The method as claimed in claim 4, wherein the reaction mixture has a metal content in a range of 1000 to 5000 ppm.

8. The method as claimed in claim 4, wherein the solution of first metal precursor is added to the solution of the second metal precursor at a temperature in a range of 30 to 60° C.

9. The method as claimed in claim 4, wherein the refluxing is performed at a temperature in a range of 65 to 100° C. for 0.5 to 6 h under constant stirring; the ageing is performed at a temperature in a range of 65 to 110° C. for 0.5 to 6 h; the solid product is separated through filtration; the solvent is selected from deionized water and methanol; the washed product is dried at a temperature in a range of 30 to 60° C.

10. A process for naphtha maximization of a petroleum feedstock through hydrocracking, the process comprises:
i. adding a catalyst to the petroleum feedstock to obtain a dispersion; wherein the catalyst comprises a first metal oxide and a second metal oxide, wherein metal of the first metal oxide is molybdenum (Mo) and metal of the second metal oxide is selected from a group comprises iron (Fe), aluminium (Al), silicon (Si) and a mixture thereof; wherein the catalyst has an atomic ratio of Mo to Fe, Al or Si in a range of 0.8 to 6, and
ii. contacting the dispersion with hydrogen under a slurry phase reaction condition to obtain a product stream.

11. The process as claimed in claim 10, wherein the dispersion is prepared by adding 0.1 to 0.5 weight % of the catalyst having a mean particle size of 4 to 25 μm, preferably 15 to 20 μm in the petroleum feedstock; the catalyst is in a solid powdered form.

12. The process as claimed in claim 10, wherein the petroleum feedstock comprises at least 3 to 5 weight % sulphur, 4 to 8 weight % CCR, 3 to 8 weight % asphaltenes and at least 30weight % hydrocarbons having a boiling point >540° C.

13. The process as claimed in claim 10, wherein the hydrocracking of the petroleum feedstock is performed under the slurry phase reaction condition at a partial pressure in a range of 80 to 100 bar, an operating temperature in a range of 370 and 420° C. and at a residence time of 0.5 to 6 h.

14. The process as claimed in claim 10, wherein the catalyst for naphtha maximization of the petroleum feedstock through hydrocracking exhibits at least 75 to 90% conversion of the hydrocarbons having the boiling point >540° C. and 25 to 40% yield of naphtha in the product stream.
